(19) United States
(12) Patent Application Publication
(10) Pub. No.: US 2018/0289580 A1
(43) Pub. Date: Oct. 11, 2018

(54) ASSIST APPARATUS AND SYSTEM

(71) Applicant: Bruce A. Grifhorst, Grand Rapids, MI (US)

(72) Inventor: Bruce A. Grifhorst, Grand Rapids, MI (US)

(21) Appl. No.: 15/577,975

(22) PCT Filed: May 31, 2016
(86) PCT No.: PCT/US16/35054

§ 371 Date: Nov. 29, 2017

Related U.S. Application Data
(60) Provisional application No. 62/169,193, filed on Jun. 1, 2015.

(51) Int. Cl. A61H 3/04; A45B 9/04

(52) U.S. Cl. CPC A61H 3/04; A45B 9/04; A61H 2201/0107; A61H 2201/0173; A61H 2201/0119

(57) ABSTRACT

A system for assisting a person to rise from or recline to a sitting position is disclosed employing a walker or cane having a connector that enables attachment and detachment with an anchor attached to the floor.

### CROSS REFERENCE TO RELATED APPLICATIONS

The present application claims the benefit of U.S. Provisional Patent Application Ser. No. 62/169,193, entitled ASSIST APPARATUS AND SYSTEM, filed on Jun. 1, 2015 the entire contents of which are incorporated by reference.

### FIELD OF THE INVENTION

The invention relates to assisting infirm people to rise from and recline to a sitting position without help of another person.

### BACKGROUND OF THE INVENTION

It is common in a private or nursing home environment for residents to use conventional stand-alone walker or canes. These residents may temporarily require the assistance of a second person to sit or stand even when using the walker or cane. Such assistance is not always available and the infirm person must wait or attempt to do it themselves with possible falls or other consequences.

### SUMMARY OF THE INVENTION

The present invention is a system for assisting a person to rise from or recline to a sitting position using a mobility assist device, such as for example a walking walker, standing cane, other cane or the like. The mobile assistance device is provided with a connector that is detachably engageable with a substrate mounted anchor device. When the connector is engaged with the anchor device, the mobile assistance device provides support for a person to pull on in the opposite direction to help the person sit or stand without the mobile assistance device becoming unstable.

These and other features, objects and advantages of the invention will be more fully understood and appreciated by reference to the description of the preferred embodiments, and the appended drawings.

### BRIEF DESCRIPTION OF THE DRAWINGS

FIG. 1 is an illustration of a modified conventional walker engaged with an anchoring device.

FIGS. 2-4 show the sequence of the slidable restraining post of an anchor device engaging with the connector where the restraining post slides from a retracted position to an extended position.

FIGS. 5-6 show another view of the slidable restraining post engaging in one of the slots of a connector.

FIG. 7 shows one embodiment of an anchoring device set into a floor.

FIG. 8 shows a second embodiment of an anchoring device set into a floor.

FIG. 9 shows a modified standing cane engaged with an anchoring device.

FIG. 10 shows an embodiment using a switchable permanent magnet connector on a walker engaged with an anchor device.

FIGS. 11 and 12 show the connector of FIG. 10 in a retracted position and engaged with an anchor device.

FIG. 13 shows the connector of FIG. 10 attached to a standing cane;

FIG. 14 is a perspective view of a connector for attachment to a mobility assist device, positioned above an anchor device, with the anchor withdrawn from its housing by the approaching magnet of the connector;

FIG. 14A is an enlarged lower, front perspective view of the anchor engaging housing of the connector of FIG. 14; and

FIG. 15 is a perspective view of an alternative embodiment anchor device which does not require use of a magnet in the connector,

### DETAILED DESCRIPTION OF THE PREFERRED EMBODIMENTS

In the following description of the preferred embodiments, the numbered parts in the Figures have the following meanings:
10—modified conventional walker
11—walker legs
11a—wheels attached to walker legs
11b lower cross piece of walker
13—connector
14—permanent magnet
16—anchor device

16a extendable anchor

12—slidable anchor restraining post

12a—stop

15—anchor head or enlarged upper portion of anchor restraining post

16b—an alternative embodiment extendable anchor

16c—biasing member for biasing extendable anchor 16b into its extended position

12b—latch engaging pins on the anchor restraining post 12 of an alternative embodiment anchor 16b
17—anchor housing
17a—alternative embodiment anchor housing
17b—anchor housing floor plate
17c—alternative anchor housing floor plate with notch openings 17d
18—collar of housing
19—spurs on outer surface of housing
20—slots
21—floor of a building
22—floor covering
23—quad cane
24—legs of quad cane
25—switchable permanent magnet connector
26—ferro magnetic horseshoe
27—rotatable permanent magnet
28—spring loaded support
29—spring
30—support bracket
31—switch
32—switch activator cable
33—steel plate anchor
34—handle
43—alternative embodiment connector

44 leg

45 anchor engaging receiver
46 magnet housing
47 slotted cavities
50—coupler
51 clamping member
   51a clamping half
   51b clamping half
   52 central body
   53 tab

55 clamping member
56 split ring clamp
   56a clamping arm
   56b clamping arm
57 “U” shaped clamp
   57a clamp arm
   57b clamp arm
   58 wing head bolt

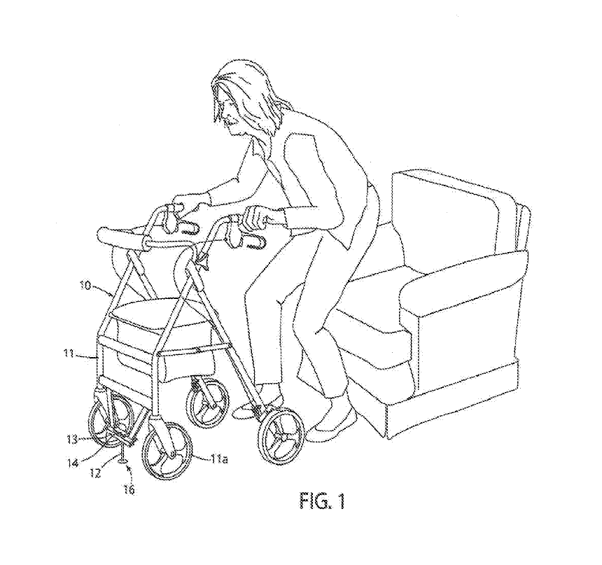

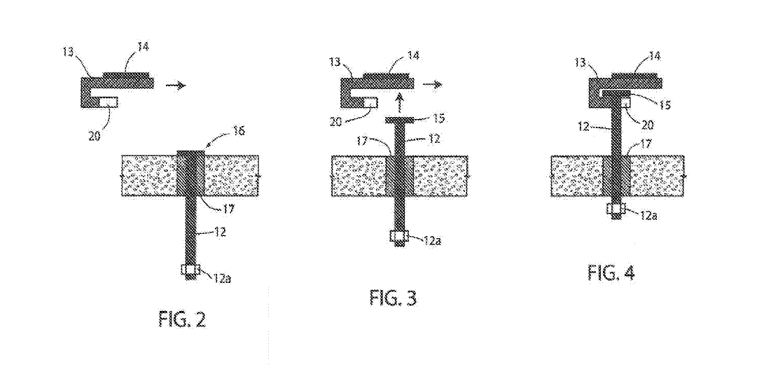

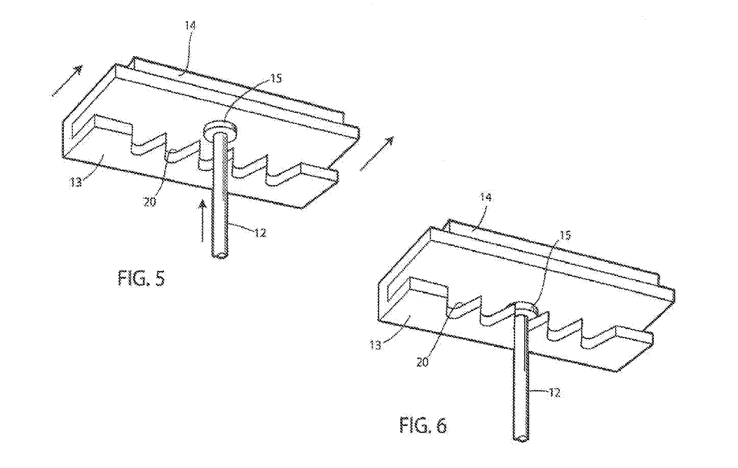

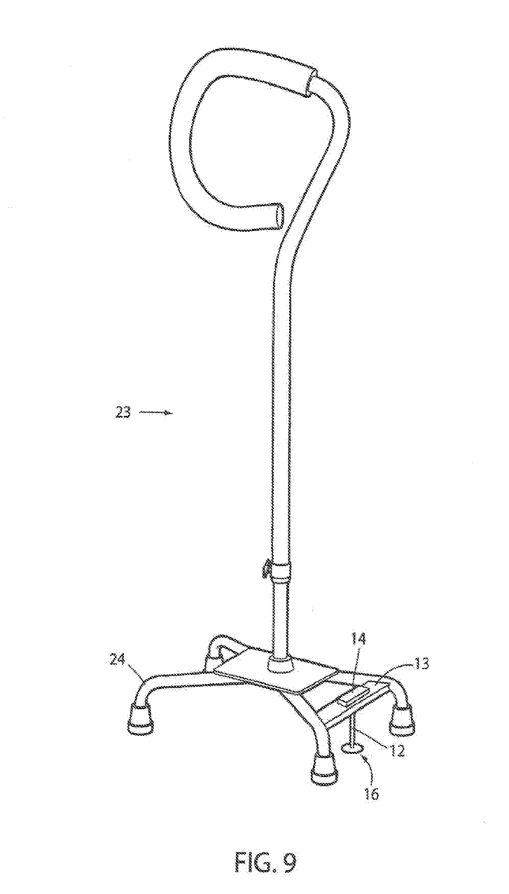

Referring to FIG. 1, there is shown a walker 10, modified by attaching a connector 13 to the bottom portion of the two front legs 11. The walker is shown with wheels 11a but other conventional walker designs can be used such as those having four legs but instead of wheels being provided with pliable end caps. The walker 10 is shown engaged with an anchor device 16 comprising an anchor 16a made of ferromagnetic material, and a housing 17 made preferably of non-ferromagnetic material. Anchor 16a includes a restraining post 12 and an enlarged upper portion 15 (FIGS. 2-4). The restraining post 12 is slideably received in housing 17 so it is free to slide up and down in the housing 17. It is prevented from completely becoming separated from the housing by having a stop 12a at the lower end. The connector 13 as shown in the embodiments of FIGS. 2-6 comprises a “1” shaped bar having slots 20 on the lower narrower portion for engaging the restraining post 12. When so engaged the walker (and the quad cane of FIG. 9) is prevented from tipping backwards when grasped by a person and used to pull him or herself to a standing position or reclining to a sitting position. The level of the slots 20 above the surface of the floor and the maximum height of the restraining post 12 are matched so that the slots will engage the post below the enlarged upper portion 15.

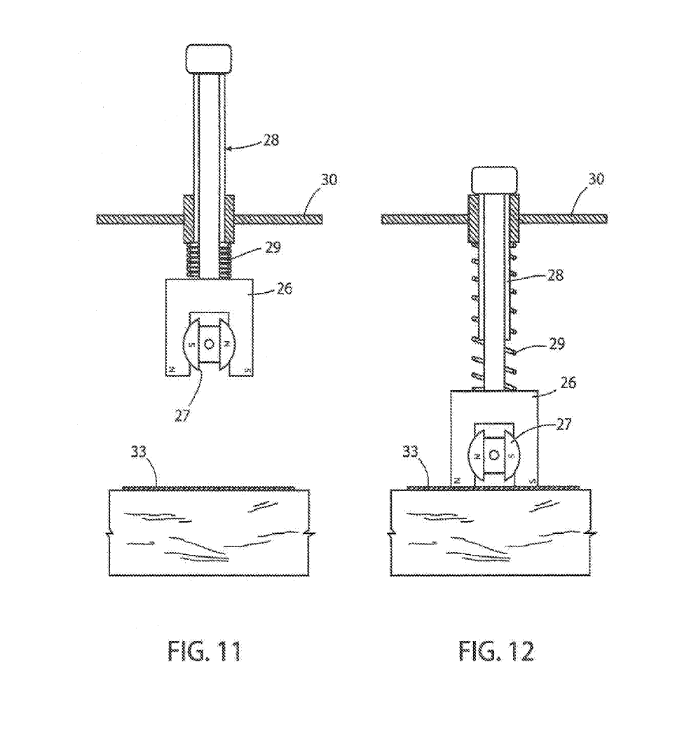

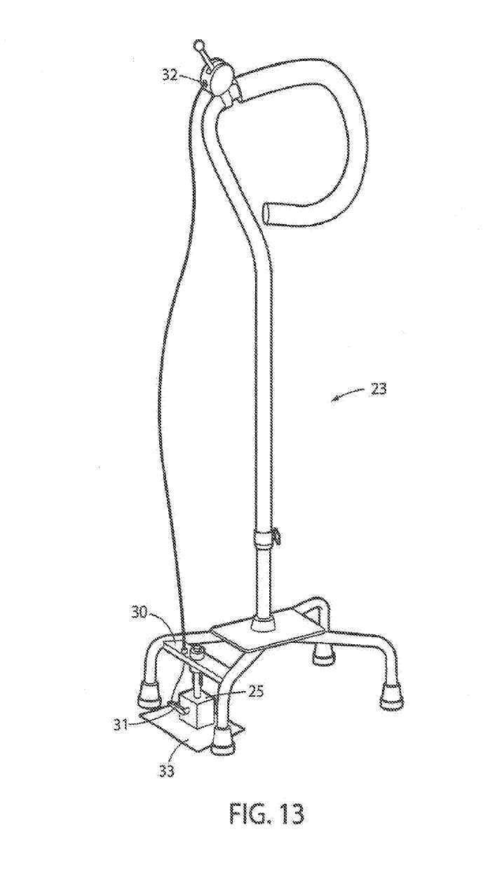

In the embodiments in FIGS. 1-14, the anchor 16a, including its restraining post 12, is pulled from the anchor housing 17 by a strong magnet 14 attached to the connector 13. To engage the post 12 with the slots the user moves the walker backwards over the anchor device 16, the magnet 14 raises the restraining post 12 and one of the slots 20 is engaged. This sequence of steps is illustrated in FIGS. 2-4. The walker can then be used by person to raise or lower himself from, or to, a sitting position because the connector-anchor engagement prevents the walker from tipping toward the person when pulling on it. Reversing the sequence of steps disengages the slot 20 from the restraining post 12 and the restraining post 12 slides back into the housing 17 of the anchor device 16. The quad cane 23 can be engaged and disengaged using the same sequence of steps.

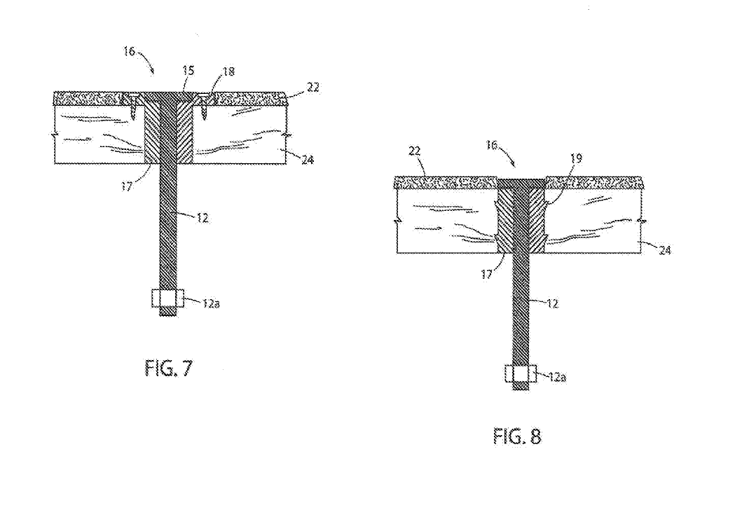

It is preferred that the top of the anchor device 16 is flush with the surface of the floor 21 to prevent tripping. Two embodiments of securing an anchor device 16 to a floor are illustrated in FIGS. 7 and 8. In FIG. 7 the anchor device 16 comprises a housing 17 having a collar 18 that can be placed in a hole in the floor and secured through the collar 18 with screws or the like. In FIG. 8 the anchor device 16 comprises a housing 17 having spurs 19 projecting from the outer surface which engaged the sides of the hole formed in the floor and secure it there. In both embodiments the restraining post 12 is slidably secured in the housing so it can easily be raised and then slide back into the housing when not being used.

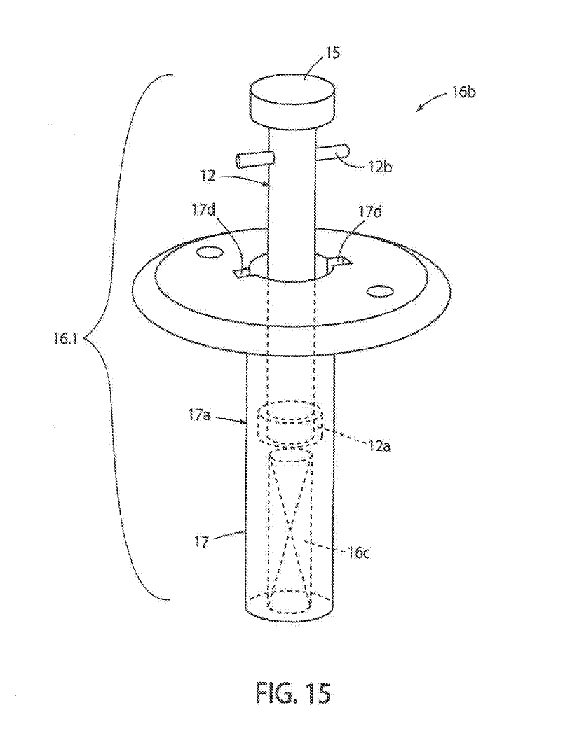

Instead of using a magnet on the connector to raise the anchor 16a of an anchor device 16, an alternative embodiment anchor device 16.1 can be used that employs a spring, magnetic or other biasing member 16c for biasing restraining post 12 partially out of housing 17 (FIG, 15). It can be retained in housing 17 by a catch, which is activated to release anchor 16a by pushing and/or twisting anchor 16b. For example, when a user steps on head 15 and pushes anchor 16b down against the biasing force of biasing member 16c, catch pins 12b pass through the notches 17d in floor plate 17c. The user then twists his or her foot slightly, to turn the catch pins 12c under floor plate 17c, thus holding anchor 16b down. By engaging anchor head 15 with the foot and twisting slightly the other way, catch pins 12b align with notches 17d, and removal of foot pressure then allows biasing member to force anchor 16b upwardly into its extended position as shown in FIG. 15. Other types of catches can be used, such as those that would catch when one pushes down on anchor 16b, but then release when anchor 16b is pressed down again. The receiver is engageable with said anchor when said anchor is projecting up from and partially out of said housing as shown in FIG. 15.

The anchor device 16 is preferably dust and dirt tight when closed to prevent dust and dirt from entering the housing 17 and disrupting sliding of the restraining post 12.

The embodiments shown in the Figures and described use a single anchor 16 device with a single restraining post 12. Multiple anchor devices 16 or an anchor device 16 having more than one restraining post 12 can be used. It is preferred that when using a single anchor device 16 and restraining post 12 the connector 13 have the slots 20 located near the center to provide a more stable walker which will not twist to one side when pulled on by a user. Preferably the anchor device 16 includes multiple aligned spaced apart restraining posts 12 that engage with multiple slots 20 to improve the stability of the walker or cane when engaged with the anchor device 16. Anchor devices 16 can be placed at various locations in a home that suit the user. Next to a bed, in a bathroom across from the toilet, in front of a favorite chair, at a dining room table and the like.

In another embodiment the anchor device 16 comprises a tie down device where the tie down ring is activated to a raised position by a magnetized connector 13. In this embodiment the connector 13 will be provided with hooks instead of slots to engage with the tie down when in a raised position.

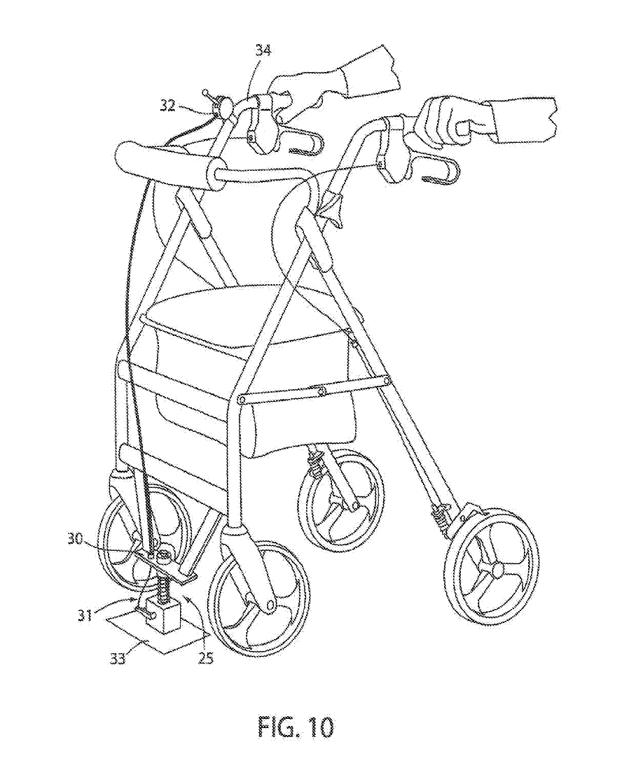

In another embodiment shown in FIGS. 10-13 the connector 13 comprises a switchable permanent magnet 25 that can be adjusted to varying magnetic field strengths. The strength of the magnetic field when active preferably should have a substantial breakaway force which allows a user to pull himself or herself up out of a seat, or lower down into a seat, without the magnetic connection to the floor anchor breaking away. Switchable permanent magnets are available with breakaway forces of at from several hundred to about a thousand pounds.

In this embodiment the anchor device 16 can comprise a magnet or ferromagnetic material such as a steel or iron plate attached flush with the floor. As shown in FIGS. 10-13 the switchable permanent magnet connector 25 comprises a ferro magnetic horseshoe 26/rotatable permanent magnet 27 combination mounted on a spring loaded support 28 and fixed to the walker or cane with a support bracket 30. The spring 29 is stretched when the connector 25 is engaged with the anchor 33 and returns the switchable permanent magnet connector 25 to an upper position when the permanent magnetic connector 25 is disengaged from the anchor device 33. The permanent magnet connector 25 includes a manual switch 31 employed by the user of the walker to rotate the rotatable permanent 27 within the horseshoe magnet 26 through a manual switch activator cable 32 running between the handle 34 of the walker and the manual switch 31 of the switchable permanent connector 25. Other switchable permanent magnets can be used. Switchable permanent magnets work on the principle that when two magnets are placed in close proximity the flux output can be increased by simple alignment of the north and south poles of each magnet with each other. En the embodiment shown the horseshoe shaped magnet 26 and a second rotatable magnet 27 are aligned with each other in the connector 25. When the rotatable magnet 27 is rotated relative to the horseshoe magnet 26 to align the north and south poles of the two magnets flux output is increased sufficiently to securely engage with the anchor 33.

The connectors can be attached to a walker or cane using clamps and the like. Similarly, a connector could be attached to a hand held assist bar, and could be used to assist a person rise by engaging a wall mounted anchor device 16.

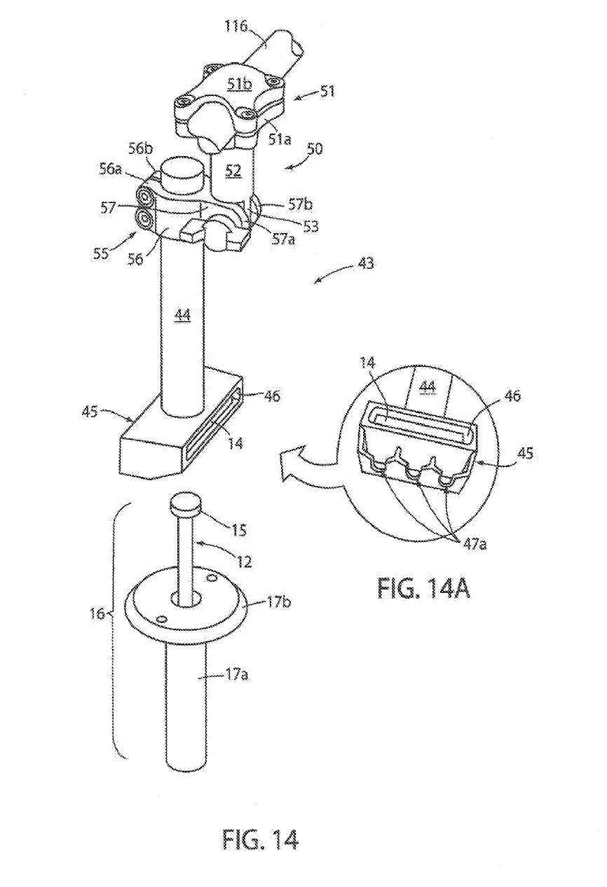

FIG. 14 shows connector 43, which is an alternative embodiment of the connector 13, coupled by a coupler 50 to the bottom cross bar of a walker, positioned above but not yet engaging the anchor head 15 of extendible anchor 16a, shown projecting up from within an alternative embodiment housing 17a. Coupler 50 comprises clamping members 51 and 55, preferably made of a slightly flexible material such as aluminum, nylon or similar polymeric material. Clamping member 51 comprises a central body portion 52 with a clamping half 51a located at one end thereof. The other clamping half 51b can be secured to clamping half 51a by suitable fasteners, such as nut and bolt combinations, with the lower cross bar of a walker, or the leg of a cane or an assist bar, clamped between the clamping halves 51a and 51b. A tab 53 projects from the other end of body 52 for connecting to clamping member 55.

Clamping member 55 comprises a split ring clamp 56 joined to a “U” shaped clamp 57. Split ring clamp 56 includes clamping arms 56a and 56b, which extend in a curvilinear manner so that they can be clamped together around the leg 44 or connector 43. Because clamping member 55 is made of a slightly flexible material, one can slide the leg 44 of a connector 43 between the clamping arms 56a and 56b, and then tighten them against one another at their ends by suitable fasteners, such as a nut and bolt combination. This clamps the leg 44 of connector 43 tightly within clamping member 55 of coupler 50. The “U” shaped clamping portion 57 has spaced arms 57a and 57b, for embracing the tab end 53 of clamping member 51. A nut and bolt type fastener can be used to clamp arms 57a and 57b tightly against tab 53. Shown specifically is a wing head bolt 58 for easy manipulation. Tab 53 is rounded so that clamping members 51 and 55 can be secured together at different angles, providing flexibility for connecting to different types of mobility assists, e.g. walkers, canes or personal assist bars as discussed above.

Alternative embodiment connector 43 is preferable made of aluminum, and comprises a leg 44 and an anchor receiver 45 on the end of leg 44. Receiver 45 comprises a magnet housing 46 in which a permanent magnet is located, and spaced slotted cavities 47, located underneath the magnet housing 46. As the receiver 45 approaches an anchor device 16, it lifts the ferromagnetic anchor 16a up out of housing 17a, allowing the user to slide one of the slotted cavities of said anchor receiver 45 over the anchor head 15, and embracing restraining post 12 within the slot of slotted cavity 47.

Alternative embodiment housing 17a is a longer housing so as to entirely close anchor 16a when it is retracted. It also includes an associated floor plate 17b.

The preferred embodiments provide a mobility device and system that permits an infirm person to use a walker, cane or the like to assist in lowering or raising him or herself to or from a sitting position with minimal assistance from a second person. The foregoing are preferred embodiments of the invention, and various changes and alterations can be made without departing from the spirit of the invention.

1. Apparatus for assisting a person to rise from or recline to a sitting position using a mobility assist device, comprising: a connector for securing to a mobility assist device: an anchor device for mounting in a support surface; said connector being detachably engageable with said anchor device, whereby when said connector is engaged with said anchor device, the mobile assistance device provides support for a person to pull on in the opposite direction to help the person sit or stand without the mobile assistance device becoming unstable.

2. The apparatus of claim 1 in which: said connector includes a magnet and a receiver for engaging said anchor device; said anchor device comprises an anchor of ferromagnetic material, slideably mounted in a housing; said receiver being engageable with said anchor when said anchor is drawn up from and partially out of said housing by said magnet.

3. The apparatus of claim 2 in which: said anchor comprises a post having an enlarged head; said connector comprises an anchor receiver which includes a magnet housing for receiving said magnet; there being a magnet located in said housing; said anchor receiver comprises at least one slotted cavity, located underneath said magnet housing, whereby as said receiver approaches said anchor device, it lifts said ferromagnetic anchor up and partially extending out of said housing, allowing a user to slide said slotted cavity of said receiver over said head said anchor, and embrace said anchor post within said slot of said slotted cavity.

4. The apparatus of claim 3 which also comprises: a coupler for coupling said connector to a mobility device.

5. The apparatus of claim 4 in which said coupler comprises a pair of clamps, one for clamping to said connector, and one for connection to said mobility device; said clamps being pivotally joined to each other such the angle of said clamps relative to one another can be adjusted.

6. The apparatus of claim 5 in which said connector comprises a let extending from said magnet housing of said receiver, one of said clamps of said connector being adjustably connectable to said leg.

7. The apparatus of claim 1 in which said connector comprises a switchable permanent magnet, and said anchor comprises a magnet or plate of ferromagnetic material, wherein the strength of the magnetic field when said switchable magnet is active creates a substantial breakaway force threshold which allows a user to pull himself or herself up out of a seat, or lower down into a seat, without the magnetic connection to the floor anchor breaking away.

8. The apparatus of claim 7 in which said switchable magnet is mounted on a biased support which can be coupled to a mobile assist device; said biased support including a biasing member which is connected to said switchable magnet, and biases said switchable magnet to a position elevated above said anchor in use; said biasing member allowing said switchable magnet to extend down and engage said anchor when said switchable magnet is activated and is attracted to said anchor, but returns said switchable magnet to said elevated position when said switchable magnet is deactivated.

9. The apparatus of claim 1 in which: said anchor device comprises an anchor slideably mounted in a housing; said anchor including an anchor head; said connector including a receiver which is engageable with said anchor head when said anchor is projecting up from and partially out of said housing; said anchor being biased to project partially out of said housing, but being retained by a catch to hold said anchor down within said housing; said catch being engaged or released by the pushing and/or twisting of said head of said anchor.

10. A walker and anchor combination for assisting a person to rise from or recline to a sitting position using a walker, said combination comprising: a walker; an anchor device for mounting in a support surface; a connector mounted on said walker for engaging said anchor device, said connector being detachably engageable with said anchor device, whereby when said anchor device is mounted in a support surface, and said connector is engaged with said anchor device, the mobile assistance device provides support for a person to pull on in the opposite direction to help the person sit or stand without the mobile assistance device becoming unstable.

11. The walker and anchor combination of claim 10 in which: said connector includes a magnet and a receiver for engaging said anchor device; said anchor device comprises an anchor of ferromagnetic material, slideably mounted in a housing; said receiver being engageable with said anchor when said anchor is drawn up from and partially out of said housing by said magnet.

12. The walker and anchor combination of claim 11 in which: said anchor comprises a post having an enlarged head; said connector comprises an anchor receiver which includes a magnet housing for receiving said magnet; there being a magnet located in said housing; said anchor receiver comprises at least one slotted cavity, located underneath said magnet housing, whereby as said receiver approaches said anchor device, it lifts said ferromagnetic anchor up and partially extending out of said housing, allowing a user to slide said slotted cavity of said receiver over said head said anchor, and embrace said anchor post within said slot of said slotted cavity.

13. The walker and anchor combination of claim 10 in which said connector comprises a switchable permanent magnet, and said anchor comprises a magnet or plate of ferromagnetic material, wherein the strength of the magnetic field when said switchable magnet is active creates a substantial breakaway force threshold which allows a user to pull himself or herself up out of a seat, or lower down into a seat, without the magnetic connection to the floor anchor breaking away.

14. The walker and anchor combination of claim 13 in which said switchable magnet is mounted on a biased support which can be coupled to a mobile assist device; said biased support including a biasing member which is connected to said switchable magnet, and biases said switchable magnet to a position elevated above said anchor in use; said biasing member allowing said switchable magnet to extend down and engage said anchor when said switchable magnet is activated and is attracted to said anchor, but returns said switchable magnet to said elevated position when said switchable magnet is deactivated.

15. The walker and anchor combination of claim 10 in which: said anchor device comprises an anchor slideably mounted in a housing; said anchor including an anchor head; said connector including a receiver which is engageable with said anchor head when said anchor is projecting up from and partially out of said housing; said anchor being biased to project partially out of said housing, but being retained by a catch to hold said anchor down within said housing; said catch being engaged or released by the pushing and/or twisting of said head of said anchor.
